(19) United States
(12) Patent Application Publication
(10) Pub. No.: US 2026/0202532 A1
(43) Pub. Date: Jul. 16, 2026

(54) INPUT DEVICE

(71) Applicant: ALPS ALPINE CO., LTD., Tokyo (JP)

(72) Inventors: Kazunori OSHIRO, Miyagi (JP); Hideki MASUDAYA, Miyagi (JP); Masahiro ISHIBASHI, Miyagi (JP)

(21) Appl. No.: 19/564,881

(22) Filed: Mar. 12, 2026

Related U.S. Application Data
(63) Continuation of application No. PCT/JP2024/008108, filed on Mar. 4, 2024.

(30) Foreign Application Priority Data
Sep. 14, 2023 (JP) 2023-149515

(51) Int. Cl. G01S 13/32; G01S 13/04; H04B 1/69

(52) U.S. Cl. CPC G01S 13/32; G01S 13/04; H04B 1/69; H04B 2001/6912

(57) ABSTRACT

An input device includes a signal generator configured to generate a waveform signal; a transmission line including a first end connected to the signal generator and a second end on an opposite side of the first end, and configured to transmit the waveform signal; a termination connected to the second end of the transmission line; and a position determination unit configured to determine, based on an input signal that is the waveform signal and input from the signal generator to the transmission line and a reflected signal generated by the input signal being reflected toward the first end by an object becoming proximate to the transmission line between the first end and the second end of the transmission line, a proximate position where the object is proximate to the transmission line.

### CROSS-REFERENCE TO RELATED APPLICATIONS

This application is a continuation application of International Application No. PCT/JP2024/008108 filed on Mar. 4, 2024, and designating the U.S., which is based upon and claims priority to Japanese patent application No. 2023-149515 filed on Sep. 14, 2023, the entire contents of which are incorporated herein by reference.

### BACKGROUND

### 1. Technical Field

The present disclosure relates to an input device.

### 2. Description of the Related Art

In the related art, there is a biometric information detection device including a microwave signal source that generates a microwave signal, a reflection-free terminated transmission line that transmits the microwave signal, and a biometric information detection means that detects, based on an incident signal input from the microwave signal source to the transmission line and a reflected signal of a leaked radio wave reflected by a person to be detected on the transmission line, biometric information of the person to be detected. The biometric information is a respiration rate and/or a heart rate, body movement, and presence/absence (for example, see Patent Document 1).

### RELATED ART DOCUMENT

### Patent Document

Patent Document 1: Japanese Laid-open Patent Application Publication No. 2020-116276

### SUMMARY

An input device according to an embodiment of the present disclosure includes a signal generator configured to generate a waveform signal; a transmission line including a first end connected to the signal generator and a second end on an opposite side of the first end, and configured to transmit the waveform signal; a termination connected to the second end of the transmission line; and a position determination unit configured to determine, based on an input signal that is the waveform signal and input from the signal generator to the transmission line and a reflected signal generated by the input signal being reflected toward the first end by an object becoming proximate to the transmission line between the first end and the second end of the transmission line, a proximate position where the object is proximate to the transmission line.

### BRIEF DESCRIPTION OF THE DRAWINGS

FIG. 1 is a diagram illustrating an example of a configuration of an input device of an embodiment;

FIG. 2A is a graph illustrating an example of a waveform of an input signal input from a signal generator to two mixers of the input device of the embodiment;

FIG. 2B is a graph illustrating an example of a waveform of an input signal input from a directional coupler to the two mixers of the input device of the embodiment;

FIG. 2C is a graph illustrating examples of an I signal and a Q signal output from the two mixers of the input device of the embodiment;

FIG. 2D is a diagram illustrating the I signal and the Q signal illustrated in FIG. 2C in IQ coordinates;

FIG. 3A is a diagram illustrating an example of a transmission line having a length Ld of λg/2 or greater of the input device of the embodiment;

FIG. 3B is a diagram illustrating an example of IQ coordinates detected when the length Ld of the transmission line of the input device of the embodiment is λg/2 or greater;

FIG. 4A is a diagram illustrating IQ coordinates obtained while the signal generator outputs a waveform signal at a plurality of frequencies as the input signal, in a state in which a position where a fingertip FT is proximate to the transmission line is fixed at a certain distance;

FIG. 4B is a graph illustrating an example of a distance spectrum obtained by inverse Fourier transform;

FIG. 4C is a graph illustrating an example of a distance spectrum obtained by inverse Fourier transform when two fingertips FT are proximate to different positions of the transmission line;

FIG. 5 is a diagram illustrating an example of a configuration of an input device according to a modified example of the embodiment;

FIG. 6A is a diagram illustrating an example of a configuration of a transmission line according to a modified example of the embodiment;

FIG. 6B is a diagram illustrating an example of a configuration of the transmission line according to a modified example of the embodiment;

FIG. 6C is a diagram illustrating an example of a configuration of the transmission line according to a modified example of the embodiment;

FIG. 6D is a diagram illustrating an example of a configuration of the transmission line according to a modified example of the embodiment;

FIG. 6E is a diagram illustrating an example of a configuration of the transmission line according to a modified example of the embodiment;

FIG. 6F is a diagram illustrating an example of a configuration of the transmission line according to a modified example of the embodiment;

FIG. 6G is a diagram illustrating an example of a configuration of the transmission line according to a modified example of the embodiment;

FIG. 6H is a diagram illustrating an example of a configuration of the transmission line according to a modified example of the embodiment;

FIG. 6I is a diagram illustrating an example of a configuration of the transmission line according to a modified example of the embodiment;

FIG. 6J is a diagram illustrating an example of a configuration of the transmission line according to a modified example of the embodiment;

FIG. 6K is a diagram illustrating an example of a configuration of the transmission line according to a modified example of the embodiment;

FIG. 6L is a diagram illustrating an example of a configuration of the transmission line according to a modified example of the embodiment;

FIG. 6N is a diagram illustrating an example of a configuration of the transmission line according to a modified example of the embodiment;

FIG. 6P is a diagram illustrating an example of a configuration of the transmission line according to a modified example of the embodiment;

FIG. 6Q is a diagram illustrating an example of a configuration of the transmission line according to a modified example of the embodiment;

FIG. 7A is a diagram illustrating an example of a configuration of a transmission line according to a modified example of the embodiment;

FIG. 7B is a diagram illustrating an example of a configuration of the transmission line according to a modified example of the embodiment;

FIG. 7C is a diagram illustrating an example of a configuration of the transmission line according to a modified example of the embodiment;

FIG. 7D is a diagram illustrating an example of a configuration of the transmission line according to a modified example of the embodiment;

FIG. 8A is a diagram illustrating an example of an application of the input device according to the embodiment to a musical instrument;

FIG. 8B illustrates operation states of a piano key and the transmission line according to the embodiment on the upper side and on the lower side;

FIG. 9A is a diagram illustrating an example of a configuration of a transmission line according to a modified example of the embodiment;

FIG. 9B is a diagram illustrating an example of a configuration of the transmission line according to a modified example of the embodiment;

FIG. 9C is a diagram illustrating an example of a configuration of the transmission line according to a modified example of the embodiment;

FIG. 9D is a diagram illustrating an example of a configuration of the transmission line according to a modified example of the embodiment; and

FIG. 9E is a diagram illustrating an example of a configuration of the transmission line according to a modified example of the embodiment.

### DETAILED DESCRIPTION

A conventional biometric information detection device detects a respiration rate, a heart rate, body movement, or presence/absence as biometric information based on an incident signal and a reflected signal, and does not detect a position where an operation input is performed by a living body serving as a target.

An input device configured to detect, based on an incident signal and a reflected signal, a position where an operation input is performed can be provided.

Hereinafter, an embodiment to which an input device of the present disclosure is applied will be described.

### Embodiment

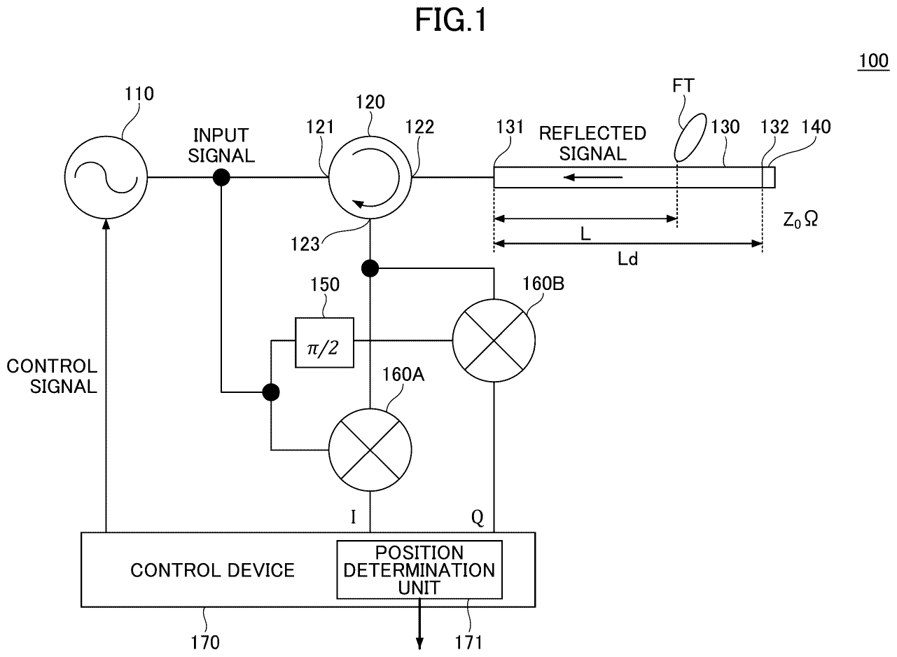

FIG. 1 is a diagram illustrating an example of a configuration of an input device 100 of the embodiment. The input device 100 includes a signal generator 110, a circulator 120, a transmission line 130, a termination resistor 140, a phase shifter 150, mixers 160A and 160B, and a control device 170. The circulator 120 is an example of a line connector. The termination resistor 140 is an example of a termination. The mixer 160A is an example of a first mixer, and the mixer 160B is an example of a second mixer.

The input device 100 is a device configured to detect a position of a fingertip FT that is proximate to the transmission line 130. The input device 100 detects the position (the proximate position) of the fingertip FT that is proximate to any position between both ends of the transmission line 130. The fingertip FT is an example of an object whose proximate position is detected by the input device 100. Any position (proximate position) between both ends of the transmission line 130 to which the fingertip FT becomes proximate is an operation position where a user of the input device 100 brings the fingertip FT proximate to a position between both ends of the transmission line 130 to perform an operation input with the fingertip FT. Here, a configuration in which the object is the fingertip FT will be described, but the object is not limited to the fingertip FT and may be a part of the fingertip FT of a hand, a part of a human body other than a hand, or the like. Additionally, the object may be a substance having a relative dielectric constant or a relative magnetic permeability that is greater than 1.

The input device 100 can be applied to various switches, such as a power window switch of an automobile and a center console, a musical instrument (keyboard), various switches for a game console, various switches for a home electric appliance, an input section of a device such as a keyboard for a personal computer (PC), or the like, for example.

The transmission line 130 is disposed in an input section of various devices as described above. The transmission line 130 is provided in an input section of various devices and is typically covered with a coating or a cover made of a resin or the like. In such a case, the fingertip FT does not directly touch the transmission line 130. The phrase that the object is proximate to the transmission line indicates that the object approaches the transmission line to such an extent that the input device 100 can detect the proximate position even if the object does not directly touch the transmission line 130.

Additionally, the transmission line 130 need not be covered with a coating, a cover, or the like, and the fingertip FT may directly touch the transmission line 130. The phrase that the object is proximate to the transmission line also indicates the object being in direct contact with the transmission line 130.

### <Configuration of Input Device 100>

### <Signal Generator 110>

The signal generator 110 is a signal generator configured to generate a waveform signal. The output terminal of the signal generator 110 is connected to a first terminal 121 of the circulator 120, the input terminal of the phase shifter 150, and one of the two input terminals of the mixer 160A. Additionally, the signal generator 110 may be driven and controlled by a control signal input from the control device 170.

The waveform signal output from the signal generator 110 is an input signal input to the transmission line 130. Additionally, a form in which the waveform signal output from the signal generator 110 is a sine wave signal will be described here, for example, but the waveform signal may be a rectangular wave. As the signal generator 110, a sine wave generator or a rectangular wave generator may be used.

### <Circulator 120>

The circulator 120 includes the first terminal 121, a second terminal 122, and a third terminal 123. The first terminal 121 is connected to the signal generator 110, the second terminal 122 is connected to the transmission line 130, and the third terminal 123 is connected to the other of the two input terminals of each of the mixers 160A and 160B. The circulator 120 transmits a signal of the signal generator 110 connected to the first terminal 121 to the transmission line 130, extracts a reflected signal component from a standing wave generated from the transmission line 130 to the second terminal 122, and outputs the reflected signal component to the mixers 160A and 160B from the third terminal 123.

### <Transmission Line 130>

The transmission line 130 is a transmission line including a conductor and a substrate, and includes a first end 131 and a second end 132 on the opposite side of the first end 131. The structure of the conductor and the substrate of the transmission line 130 will be described later, but the conductor is provided between the first end 131 and the second end 132.

The first end 131 is connected to the second terminal 122 of the circulator 120, and the termination resistor 140 is connected to the second end 132. It is desirable that the amount of reflection at the termination is small. If there is reflection, the influence of the reflected wave at the termination can be eliminated. For example, the reflected wave at the termination is measured in advance and can be corrected using the measured data. The characteristic impedance of the transmission line 130 is Z0 (for example, 50Ω). The length between the first end 131 and the second end 132 of the transmission line 130 is Ld. The length Ld is the length of the transmission line 130.

The transmission line 130 may be either a type in which the electromagnetic fields are not confined or a type in which the electromagnetic fields are confined. Transmission lines of the type in which the electromagnetic fields are not confined include microstrip lines, coplanar waveguides, and the like. Transmission lines of the type in which the electromagnetic fields are confined include triplate striplines, coaxial cables, and the like. Specific examples of these will be described later with reference to the drawings.

The transmission line 130 transmits a waveform signal. More specifically, the transmission line 130 transmits an input signal input to the first end 131. When the fingertip FT is not proximate to the transmission line 130, most of the input signal is absorbed by the termination resistor 140 having a resistance value Z0 (for example, 50Ω), and virtually no reflection occurs. In such a way, the fact that virtually no reflection occurs is theoretically equivalent to zero reflection.

When the fingertip FT becomes proximate to an intermediate position of the transmission line 130 as illustrated in FIG. 1, the impedance of the transmission line 130 changes at the proximate position where the fingertip FT is proximate to the transmission line 130, so that the characteristic impedance of the transmission line 130 deviates from Z0. Therefore, when the fingertip FT is proximate to some point along the transmission line 130 (some point between the first end 131 and the second end 132) as illustrated in FIG. 1, the input signal absorbed by the termination resistor 140 decreases, and the reflected signal reflected to the first end 131 greatly increases. In such a way, the fact that the reflected signal greatly increases is theoretically equivalent to switching from a state in which no reflection occurs to a state in which reflection occurs. Due to the generation of the reflected wave, a standing wave is generated between the first terminal of the transmission line 130 and the position where the fingertip FT becomes proximate. A reflected wave component generated at the fingertip FT is extracted from the standing wave by the circulator 120 connected to the first end 131 of the transmission line 130, and the reflected wave component is output from the third terminal of the circulator 120. The reflected signal is input to the circulator 120 from the first end 131 and output from the third terminal 123.

### <Termination Resistor 140>

The termination resistor 140 is a termination resistor connected to the second end 132 of the transmission line 130, and has a resistance value Z0 equal to the characteristic impedance Z0 of the transmission line 130. Therefore, in a state in which the fingertip FT is not proximate to the transmission line 130, virtually no reflection of the input signal occurs at the second end 132.

### <Phase Shifter 150>

The phase shifter 150 has an input terminal connected to the output terminal of the signal generator 110 and an output terminal connected to one of the two input terminals of the mixer 160B. The phase shifter 150 is a phase shifter and shifts the phase of the input signal that is input to the input terminal by π/2 (90 degrees) and outputs the shifted input signal to the mixer 160B.

### <Mixer 160A>

The mixer 160A includes two input terminals connected to the output terminal of the signal generator 110 and the third terminal 123 of the circulator 120, and an output terminal connected to the control device 170. The mixer 160A mixes the input signal that is input from the signal generator 110 with the reflected signal component of the standing wave that is input from the circulator 120 to generate a first signal and outputs the first signal to the control device 170. The first signal (an example of a first signal) is an I (in-phase) signal.

### <Mixer 160B>

The mixer 160B includes two input terminals connected to the output terminal of the phase shifter 150 and the third terminal 123 of the circulator 120, and an output terminal connected to the control device 170. The mixer 160B mixes the input signal whose phase is shifted by π/2 that is input from the phase shifter 150 with the reflected signal component of the standing wave input from the circulator 120 to generate a second signal, and outputs the second signal to the control device 170. The second signal (an example of a second signal) is a Q (quadrature-phase) signal. The phase of the Q signal differs from that of the I signal by 90 degrees.

### <Control Device 170>

The control device 170 includes a position determination unit 171. The control device 170 is implemented by a computer including a central processing unit (CPU), a random access memory (RAM), a read only memory (ROM), an input/output interface, an internal bus, and the like.

The position determination unit 171 represents a function of a program executed by the control device 170 as a functional block. The control device 170 includes, in addition to the position determination unit 171, a drive control unit or the like configured to control the drive of the signal generator 110, but this will be omitted here.

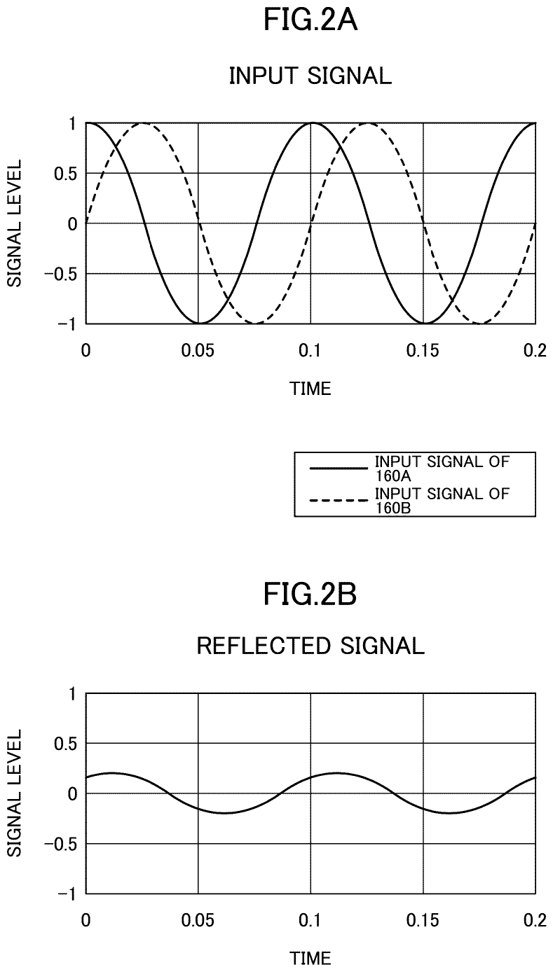

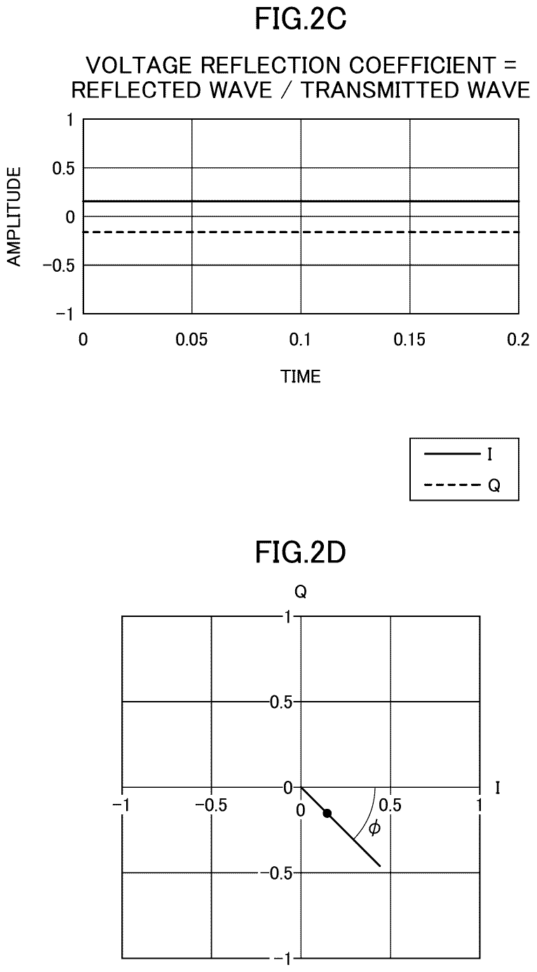

The position determination unit 171 determines the proximate position based on the input signal that is input from the signal generator 110 to the transmission line 130 and the reflected signal. Specifically, the position determination unit 171 determines the proximate position based on the I signal generated based on the input signal and the reflected signal and the Q signal generated based on the input signal and the reflected signal. More specifically, the position determination unit 171 determines the proximate position based on the first signal (I signal) output from the mixer 160A and the second signal (Q signal) output from the mixer 160B. A method of the position determination unit 171 determining the proximate position of the fingertip FT will be described with reference to FIGS. 2A to 2D.

Next, a method of determining the proximate position of the fingertip FT when the length Ld between the first end 131 and the second end 132 of the transmission line 130 is less than λg/2 and a method of determining the proximate position of the fingertip FT when the length Ld between the first end 131 and the second end 132 of the transmission line 130 is λg/2 or greater will be described. λg is the effective length of the wavelength λ in the transmission line, and λg is obtained by multiplying λ of a radio wave at the frequency of the input signal in free space by the reciprocal of the square root of the effective relative permittivity er of the transmission line 130.

The effective length λg is expressed by the following Equation (1):

$$[ Eq . 1 ]$$

$$λ g = λ / √ ε r \qquad ( 1 )$$

<Method of Determining Proximate Position of Fingertip FT when Length Ld is Less than λg/2>

FIG. 2A is a graph illustrating examples of waveforms of the input signals input to the mixers 160A and 160B. In FIG. 2A, the horizontal axis represents the time axis, and the vertical axis represents the signal level of the input signal. As illustrated in FIG. 2A, the input signals input to the mixers 160A and 160B differ in phase by π/2. FIG. 2A illustrates waveforms normalized so that the amplitude of the input signal becomes 1.

FIG. 2B is a graph illustrating an example of a waveform of the reflected signal input to the mixers 160A and 160B. In FIG. 2B, the horizontal axis represents the time axis, and the vertical axis represents the signal level of the reflected signal. FIG. 2B illustrates, for example, the waveform of the reflected signal in a state in which the fingertip FT is stationary at a position that is a distance L from the first end 131. That is, the distance L is the distance between the first end 131 and the proximate position where the fingertip FT is proximate to the transmission line 130. The reflected wave reflected by the fingertip FT is a part of the incident signal, and thus the amplitude of the reflected signal is smaller than the amplitude of the input signal. Additionally, the phase of the reflected signal at the first end 131 is delayed by an amount corresponding to the distance L from the input signal at the first end 131.

FIG. 2C is a graph illustrating an example of the I signal and the Q signal output from the mixers 160A and 160B. In FIG. 2C, the horizontal axis represents the time axis, and the vertical axis represents the I signal and the Q signal.

The ratio of the amplitudes of the I signal and the Q signal is represented by the voltage reflection coefficient of the reflected signal for the input signal. In a state in which the fingertip FT is stationary, the phase of the reflected wave is delayed from the phase of the input signal by an amount corresponding to the distance L, so that the I signal and the Q signal, which are the outputs of the mixers 160A and 160B, become constant as illustrated in FIG. 2C.

FIG. 2D is a diagram illustrating the I signal and the Q signal illustrated in FIG. 2C in IQ coordinates. In FIG. 2D, the horizontal axis is the I axis representing the signal level of the I signal, and the vertical axis is the Q axis representing the signal level of the Q signal. In FIG. 2D, q is the phase of the reflected wave.

Additionally, when the length Ld of the transmission line 130 is less than λg/2, the phase of the reflected wave and the distance L have a one-to-one relationship, and thus the distance L can be obtained relatively easily as described below.

The phase q of the reflected signal (see FIG. 2D) is expressed by tan φ=Q/I. Additionally, the reflected signal is expressed by the following Equation (3). In Equation (3), B is a predetermined constant, and Le is the electric length of the distance L that is obtained by multiplying the distance L by the square root of the effective relative permittivity er of the transmission line 130, which is hereinafter referred to as Le.

The relationship between Le and the distance L is expressed by the following Equation (2). Additionally, f is the frequency of the reflected signal and is equal to the frequency of the input signal. c is the speed of the radio wave in vacuum.

$$[ Eq . 2 ]$$

$$Le = √ ε r \times L \qquad ( 2 )$$

$$[ Eq . 3 ]$$

$$REFLECTED WAVE = \vert B \vert {e}^{i ϕ} = \vert B \vert {e}^{- 4 π ifLe / c} \qquad ( 3 )$$

When the length Ld of the transmission line 130 is less than λg/2, assuming that the phase of the reflected signal is φ0 when Le=0, from Equation (3), the phase of the reflected signal when the distance between the first end 131 and the proximate position where the fingertip FT is proximate to the transmission line 130 is L is expressed by the following Equation (4).

$$[ Eq . 4 ]$$

$$ϕ = ϕ0 - \frac{4 π fLe}{c} = 2 π n \qquad ( 4 )$$

Here, n=0 when φ−φ0≤0, and n=1 when φ−φ0>0

From Equation (4), the distance L between the first end 131 and the proximate position where the fingertip FT is proximate to the transmission line 130 is expressed by the following Equation (5):

$$[ Eq . 5 ]$$

$$\begin{matrix}When ϕ - ϕ0 \leq 0 , Le = - \frac{c}{4 π f} ( ϕ - ϕ0 ) \\ When ϕ - ϕ0 > 0 , Le = 2 π - \frac{c}{4 π f} ( ϕ - ϕ0 )\end{matrix} \} \qquad ( 5 )$$

The distance L may be obtained according to Equation (6) from Le obtained by Equation (5).

$$[ Eq . 6 ]$$

$$L = Le / √ ε r \qquad ( 6 )$$

Because φ0 can be known in advance, as described above, if the phase φ of the reflected signal is obtained from the I signal and the Q signal, the distance L between the proximate position where the fingertip FT is proximate to the transmission line 130 and the first end 131 can be obtained from Equation (6), and the proximate position of the fingertip FT can be determined. The calculation as described above may be performed by the position determination unit 171.

(Method of Determining Proximate Position of Fingertip FT when Length Ld is λg/2 or Greater)

When the length Ld of the transmission line 130 is λg/2 or greater, because the phase of the reflected wave and the distance L are not one-to-one, L cannot be determined as described above.

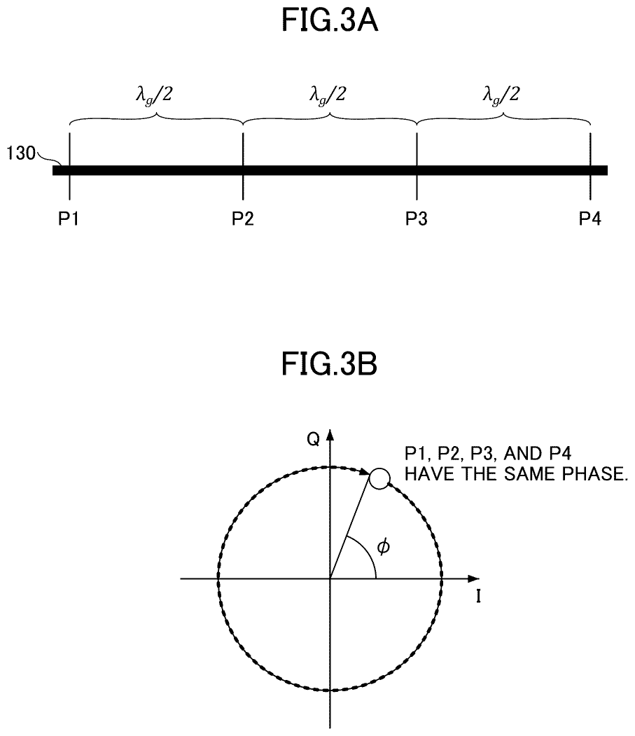

FIG. 3A is a diagram illustrating an example of the transmission line 130 having a length Ld that is greater than or equal to λg/2. FIG. 3B is a diagram illustrating an example of IQ coordinates detected when the length Ld of the transmission line 130 is greater than or equal to λg/2.

As illustrated in FIG. 3A, it is assumed that there are points P1, P2, P3, and P4 at intervals of λg/2 along the transmission line 130. When the fingertip FT becomes proximate to such points P1, P2, P3, and P4, the phases φ obtained from the I signal and the Q signal are all the same, as illustrated in FIG. 3B. That is, when the fingertip FT that is proximate to the transmission line 130 having the length Ld that is greater than or equal to λg/2 moves along the transmission line 130, every time the fingertip FT moves by a distance corresponding to λg/2, the IQ coordinates rotate once, and thus the phase of the reflected wave and the distance L are not one-to-one.

For this reason, when the length Ld of the transmission line 130 is greater than or equal to λg/2, the distance L can be obtained as follows.

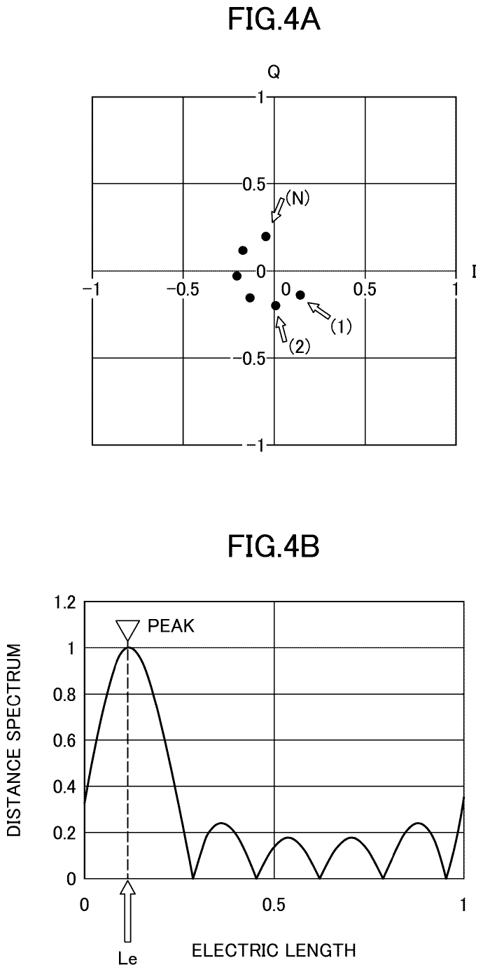

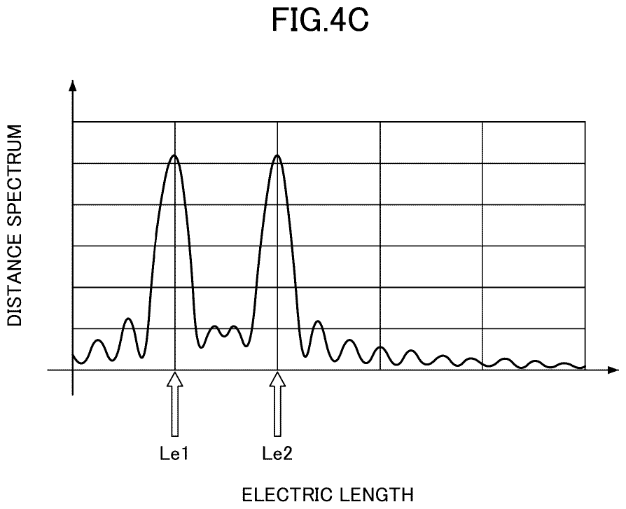

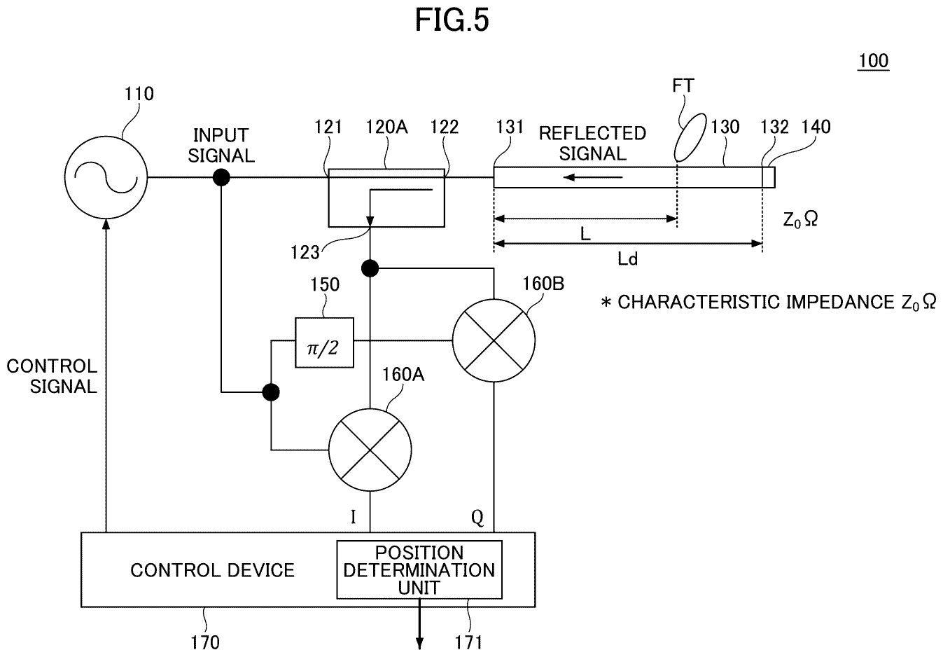

FIG. 4A is a diagram illustrating IQ coordinates obtained while a waveform signal at a plurality of frequencies is output as the input signal by the signal generator 110 in a state in which the position where the fingertip FT is proximate to the transmission line 130 is fixed at a certain distance. Here, it is assumed that IQ coordinates of (1) to (N) are obtained as a result of obtaining N IQ coordinates using the input signal at N kinds of frequencies, where Nis an integer of two or greater.

Here, a form of obtaining N IQ coordinates of (1) to (N), using the input signal at N kinds of frequencies will be described. However, instead of using the input signal at the plurality of frequencies, a chirp signal in which the frequency changes continuously may be used.

An example of a method of determining the proximate position using a plurality of voltage reflection coefficients obtained for the plurality of frequencies will be described below.

The IQ coordinates for each of the frequencies are regarded as a function of frequency f, and inverse Fourier transform is performed, thereby obtaining a function of time t. A function of distance x is obtained by multiplying the time t by the velocity c and dividing it by 2 because it is a round trip. The absolute value of the function of distance is the distance spectrum. The peak position of the distance spectrum provides Le.

FIG. 4B is a graph illustrating an example of the distance spectrum obtained by inverse Fourier transform. In FIG. 4B, the horizontal axis indicates the electric length, and the vertical axis indicates the signal level of the distance spectrum. The electric length giving the peak in the distance spectrum is the electric length Le at the position where the fingertip FT is proximate to the transmission line 130. In such a way, the electric length Le can be detected.

Then, by substituting the electric length Le into Equation (6) above, the distance L can be obtained. In such a way, it can be detected that the proximate position of the fingertip FT is the position at the distance L from the first end 131 when the length Ld of the transmission line 130 is λg/2 or greater. Such calculation may be executed by the position determination unit 171. This method is also applicable to the case where the length Ld of the transmission line 130 is less than λg/2.

Although the case where there is only one target to be detected has been described above, in the case where there are a plurality of targets to be detected, the target positions can be detected by obtaining the distance spectrum.

In the case where two fingertips FT are proximate to different positions of the transmission line 130, for example, the distance spectrum illustrated in FIG. 4C is obtained by inverse Fourier transform. FIG. 4C is a graph illustrating an example of the distance spectrum obtained by inverse Fourier transform in the case where the two fingertips FT are proximate to the different positions of the transmission line 130.

As illustrated in FIG. 4C, peaks are obtained at two positions of the electric lengths Le1 and Le2. By substituting the electric lengths Le1 and Le2 into Equation (6) above, distances L1 and L2 can be obtained. In such a way, when the two fingertips FT are proximate to the different positions of the transmission line 130, the proximate positions of the two fingertips FT can be detected as the distances L1 and L2. The distances L1 and L2 are distances from the first end 131. Such calculation may be performed by the position determination unit 171. Here, the case where the two fingertips FT as two targets are proximate to the transmission line 130 are described, but the two targets are not limited to the fingertips FT and may be a part of the fingertips FT of the hand or a part of a human body other than the hand. Additionally, a substance having a relative permittivity or a relative permeability that is greater than 1 may be used.

### <Input Device 100 of Modified Example>

FIG. 5 is a diagram illustrating an example of a configuration of an input device 100 of a modified example of the embodiment. The input device 100 illustrated in FIG. 5 includes the signal generator 110, a directional coupler 120A, the transmission line 130, the termination resistor 140, the phase shifter 150, the mixers 160A and 160B, and the control device 170. The input device 100 illustrated in FIG. 5 includes the directional coupler 120A instead of the circulator 120 (see FIG. 1). The other configurations are the same as those of the input device 100 illustrated in FIG. 1. Here, the directional coupler 120A will be described. The directional coupler 120A is an example of a line connector.

### <Directional Coupler 120A>

The directional coupler 120A includes the first terminal 121, the second terminal 122, and the third terminal 123. The first terminal 121 is connected to the signal generator 110, the second terminal 122 is connected to the transmission line 130, and the third terminal 123 is connected to the other of the two input terminals of each of the mixers 160A and 160B. A section between the first terminal 121 and the second terminal 122 of the directional coupler 120A is inserted between the signal generator 110 and the transmission line 130, the directional coupler 120A extracts a reflected signal component from a standing wave generated from the transmission line 130 to the second terminal 122, and outputs the reflected signal component from the third terminal 123 to the mixers 160A and 160B.

As described above, the operation of the input device 100 including the directional coupler 120A is the same as the operation of the input device 100 including the circulator 120, and the proximate position of the fingertip FT can be determined.

### <Variation of Transmission Line 130>

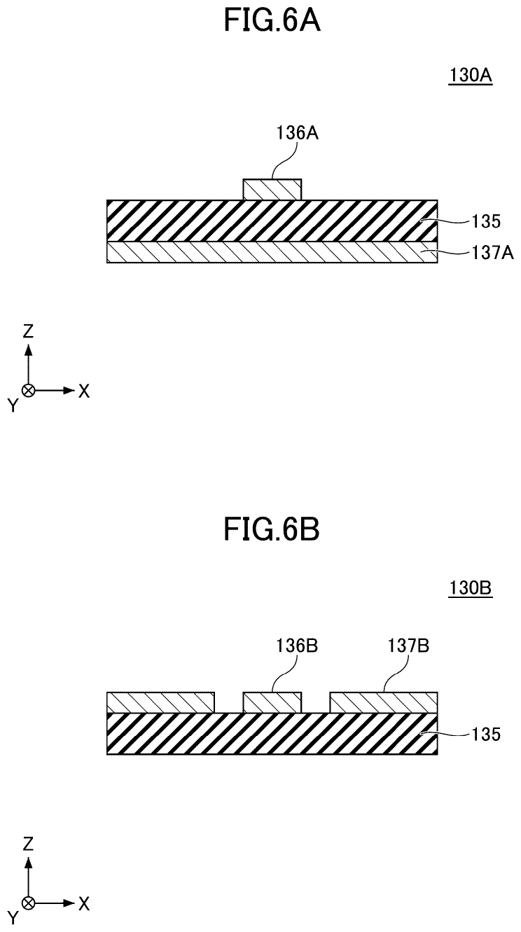

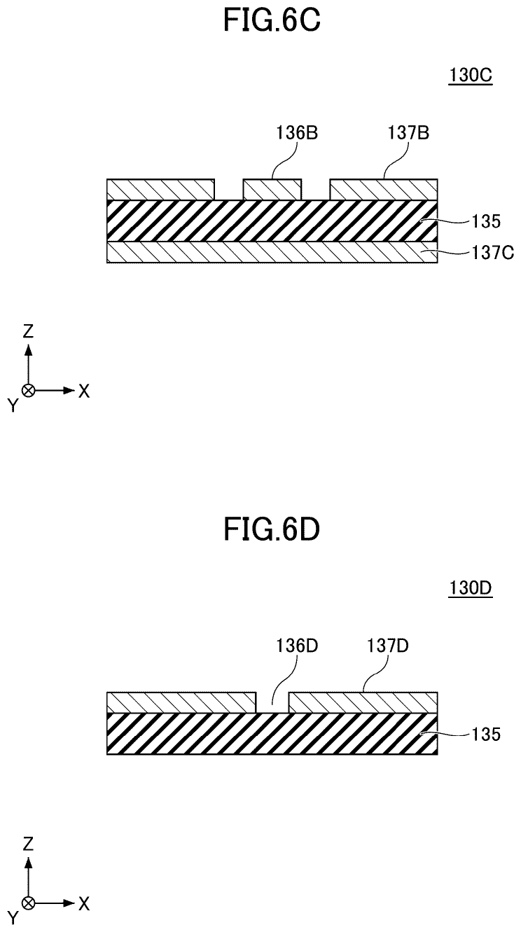

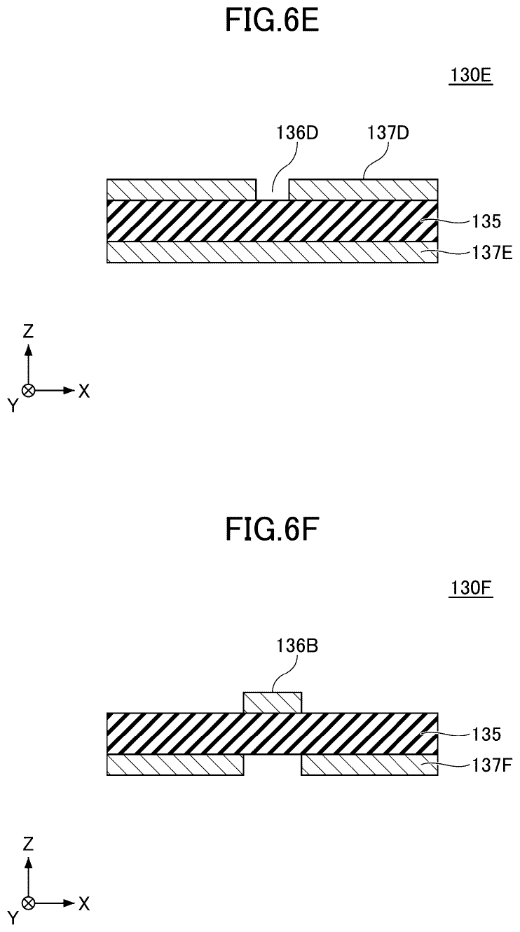

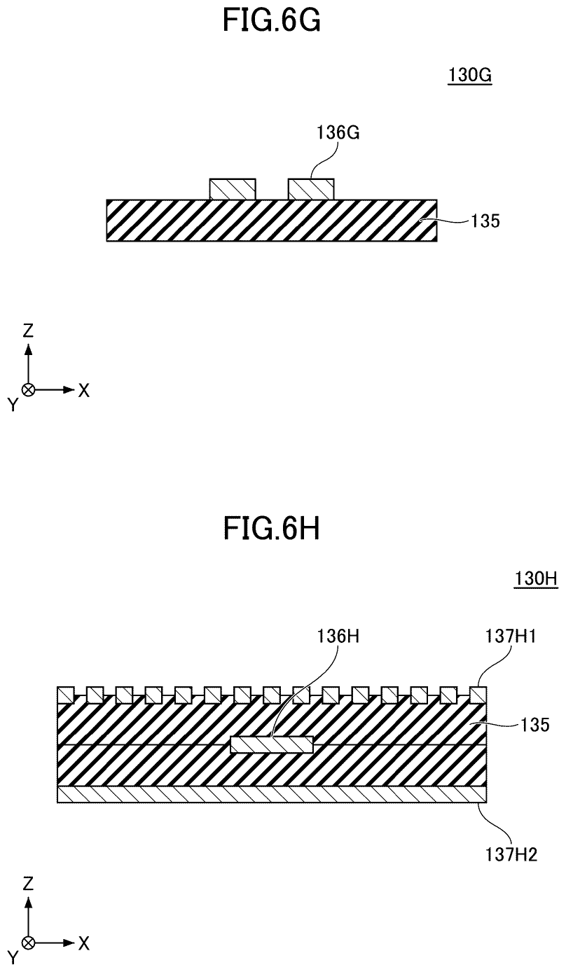

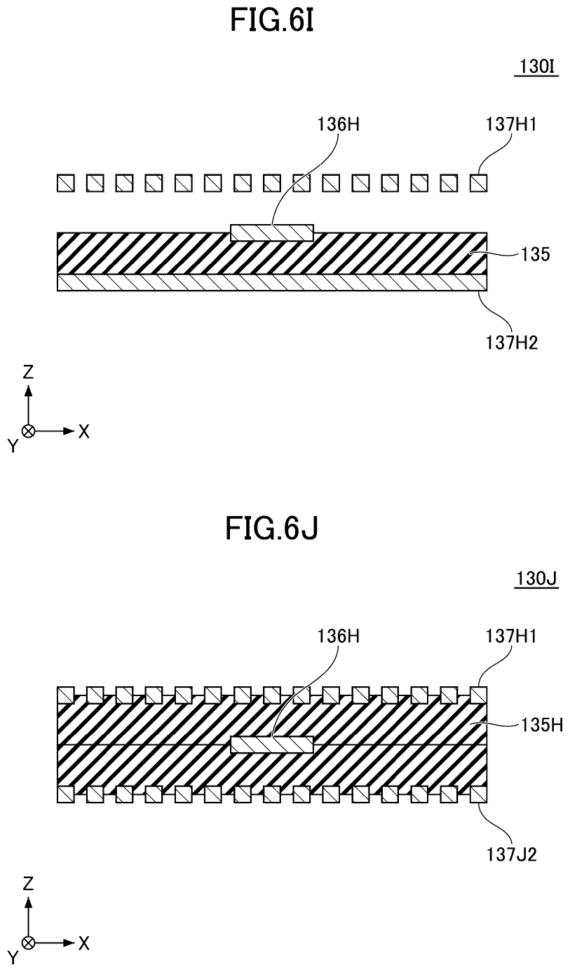

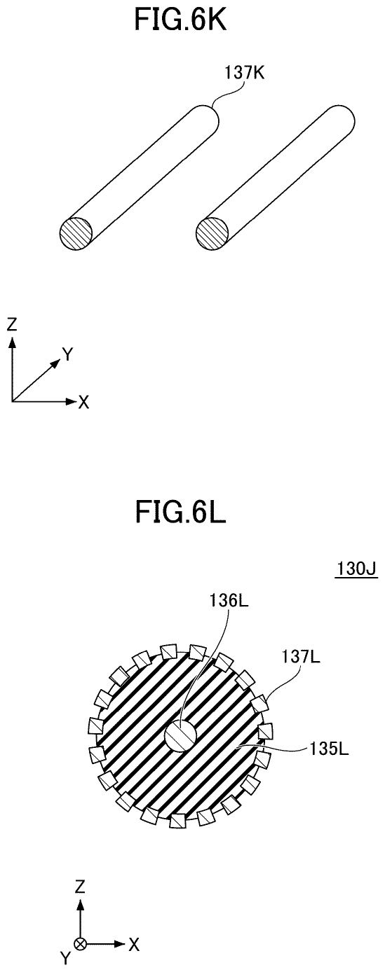

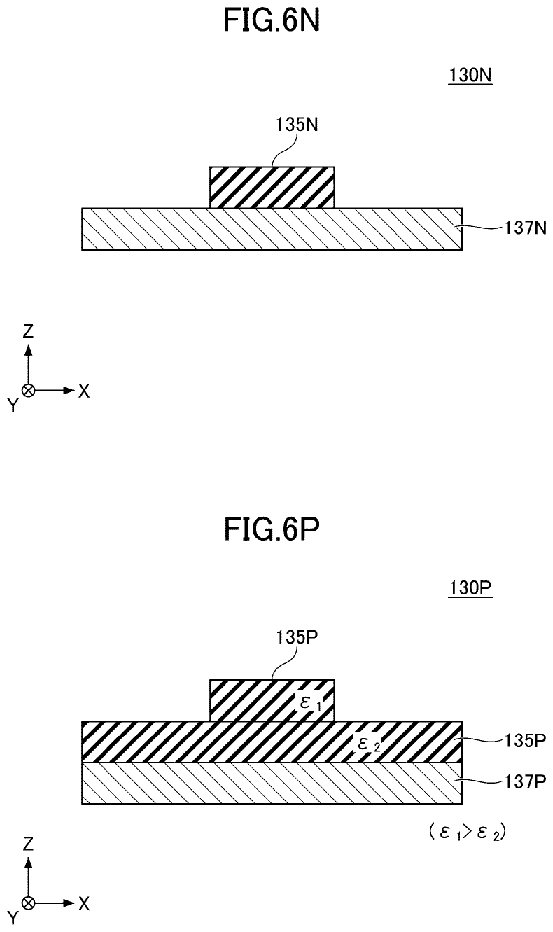

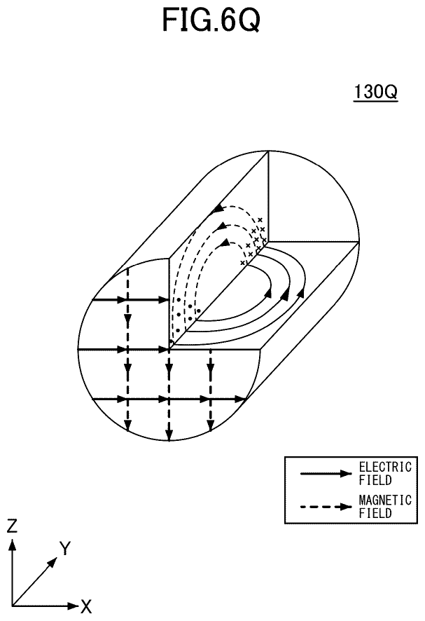

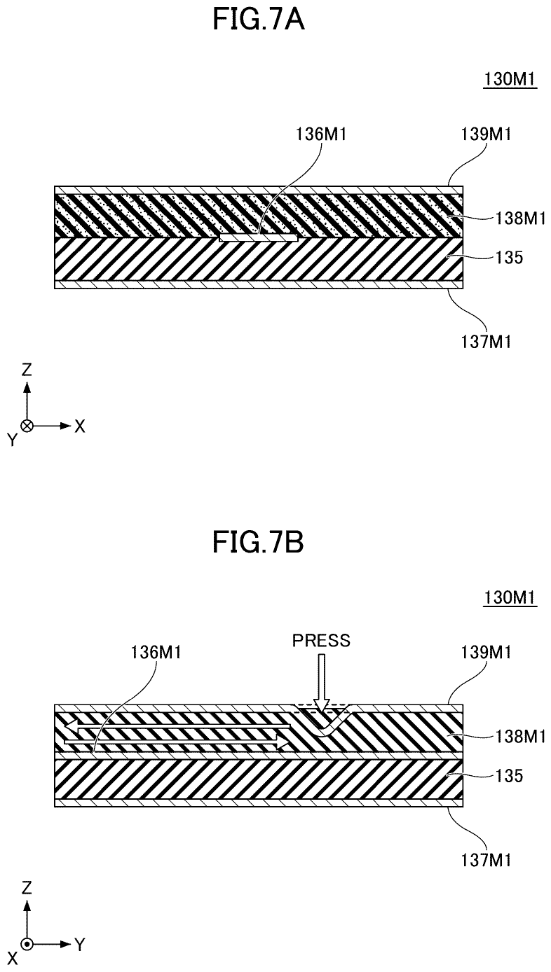

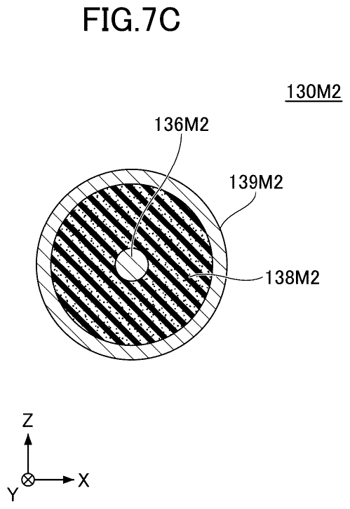

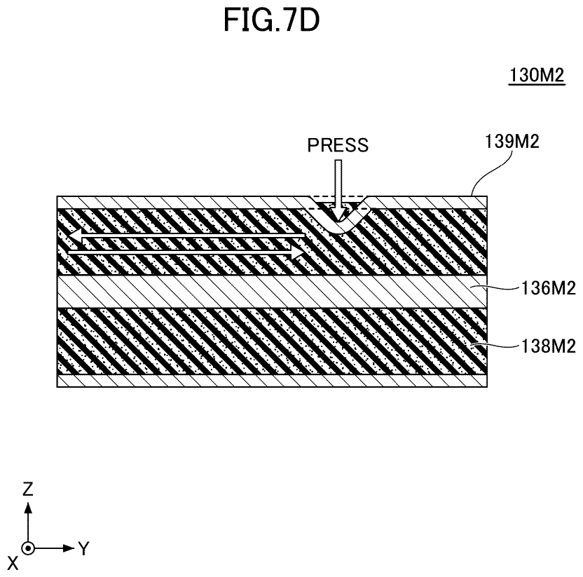

FIGS. 6A to 6Q and FIGS. 7A to 7D are diagrams illustrating examples of configurations of transmission lines 130A to 130Q and 130M1 to 130M2 of modified examples. The transmission lines 130A to 130Q and 130M1 to 130M2 can be used instead of the transmission line 130 illustrated in FIG. 1. In the following, the description will be provided by using upper and lower surfaces of a substrate 135, but they do not represent a universal vertical relationship.

Here, the description is provided by defining the XYZ coordinate system. The direction parallel to the X axis (the X direction), the direction parallel to the Y axis (the Y direction), and the direction parallel to the Z axis (the Z direction) are orthogonal to each other. Additionally, plan view refers to viewing in the XY plane. Additionally, in the following, the length, thickness, width, and the like of each part are sometimes exaggerated to make the structure easy to understand. The Y direction is the direction of the transmission lines 130A to 130Q and 130M1 to 130M2.

<Type of Transmission Line in which Electromagnetic Fields are not Confined>

The transmission lines 130A to 130Q illustrated in FIGS. 6A to 6Q are a type of a transmission line in which electromagnetic fields are not confined.

The transmission line 130A illustrated in FIG. 6A is a transmission line formed of a microstrip line including the substrate 135, a line 136A, and a ground layer 137A. The substrate 135 is formed of an insulator and is, for example, a flexible substrate, such as an FR4 (flame retardant type 4) or a rigid substrate. The line 136A and the ground layer 137A are, for example, formed of a conductor, such as copper foil. The line 136A is formed on the upper surface of the substrate 135, and the ground layer 137A is formed on the lower surface of the substrate 135. The line 136A and the ground layer 137A extend from the first end 131 to the second end 132.

The transmission line 130B illustrated in FIG. 6B is a transmission line formed of a coplanar waveguide including the substrate 135, a line 136B, and a ground layer 137B. The line 136B and the ground layer 137B are formed of a conductor, such as copper foil, for example. The line 136B and the ground layer 137B are formed on the upper surface of the substrate 135, and the ground layers 137B are provided on both sides of the line 136B and extends from the first end 131 to the second end 132 along the line 136B.

The transmission line 130C illustrated in FIG. 6C includes the substrate 135, a line 136B, and ground layers 137B and 137C. The transmission line 130C is a transmission line formed of a grounded coplanar wave guide in which the ground layer 137C is added to the back side of the substrate 135 of the transmission line 130B illustrated in FIG. 6B.

The transmission line 130D illustrated in FIG. 6D is a transmission line formed of a slot line including the substrate 135 and a ground layer 137D. The ground layer 137D is formed on the upper surface of the substrate 135, and a slot 136D is formed from the first end 131 to the second end 132.

The transmission line 130E illustrated in FIG. 6E is a transmission line formed of a grounded slot line in which a ground layer 137E is provided on the back side of the substrate 135 of the transmission line 130E illustrated in FIG. 6D.

The transmission line 130F illustrated in FIG. 6F is a transmission line formed of a modified coplanar waveguide in which the ground layer 137B of the transmission line 130B illustrated in FIG. 6B is provided as a ground layer 137F on the lower surface side of the substrate 135.

The transmission line 130G illustrated in FIG. 6G includes two parallel lines 136G formed on the upper surface of the substrate 135. A differential signal, a signal of the same phase, or a signal of the opposite phase can be passed through the two parallel lines 136G.

The transmission line 130H illustrated in FIG. 6H is a transmission line of a triplate structure including two substrates 135, a line 136H, and ground layers 137H1 and 137H2. The substrate 135 on the lower side and the line 136H correspond to the substrate 135 and the line 136A of the transmission line 130A illustrated in FIG. 6A. The transmission line 130H has a structure in which another substrate 135 is stacked on the line 136A of the transmission line 130A illustrated in FIG. 6A, and the mesh-shaped ground layer 137H1 is provided thereon. Because the ground layer 137H1 has a mesh shape, the electromagnetic fields are not confined and propagate in the upward direction of the transmission line 130H.

The transmission line 130I illustrated in FIG. 6I has a configuration in which the substrate 135 on the upper side is omitted from the transmission line 130H illustrated in FIG. 6H. The transmission line 130I is a transmission line having a triplate structure. The ground layer 137H1 may be provided in a member (for example, the housing of the input device 100), which is not illustrated in FIG. 6I. Because the ground layer 137H1 has a mesh shape, the electromagnetic fields are not confined and propagate in the upward direction of the transmission line 130H.

The transmission line 130J illustrated in FIG. 6J has a configuration in which the ground layer 137H2 of the transmission line 130H illustrated in FIG. 6H is changed to a mesh metal layer. The transmission line 130J is a transmission line having a triplate structure. Because the ground layers 137H1 and 137H2 have a mesh shape, the electromagnetic fields are not confined and propagate in the upward and downward direction of the transmission line 130H.

The transmission line 130K illustrated in FIG. 6K is a pair of conductive wires. Because the pair of conductive wires of the transmission line 130K is not covered with a ground layer or the like, the electromagnetic fields are not confined and propagate around the conductive wires.

The transmission line 130L illustrated in FIG. 6L is the transmission line 130 in which the periphery of a conductive wire 136L is covered with an insulating layer 135L and a mesh-shaped ground layer 137L is provided on the side surface of the insulating layer 135L. Because the ground layer 137L has a mesh shape, the electromagnetic fields are not confined and propagate to the outside of the mesh-shaped ground layer 137L.

The transmission line 130N illustrated in FIG. 6N is a dielectric image line in which a dielectric piece 135N is disposed on a ground layer 137N. The dielectric piece 135N and the ground layer 137N extend between the first end 131 and the second end 132. A radio wave is transmitted along the dielectric piece 135N.

The transmission line 130P illustrated in FIG. 6P is a dielectric image line in which a dielectric piece 135P is provided between the dielectric piece 135N and the ground layer 137N illustrated in FIG. 6N. The dielectric piece 135P is provided on the entirety of the upper surface of the ground layer 137N. The relative permittivity ε1 of the dielectric piece 135N is greater than the relative permittivity ε2 of the dielectric piece 135P (ε1>ε2). Therefore, a radio wave is confined in the dielectric piece 135P, and the radio wave is transmitted along the dielectric piece 135P.

The transmission line 130Q illustrated in FIG. 6Q is formed of a cylindrical dielectric. The cylindrical dielectric forming the transmission line 130Q extends between the first end 131 and the second end 132. FIG. 6Q illustrates a state of the electric field and the magnetic field inside the cylindrical dielectric by removing ¼ of its circular shape. The electric field and the magnetic field are orthogonal to each other. As described, a radio wave may be transmitted through the transmission line 130Q that does not include a conductor. Here, an antenna or the like may be provided at the end of the transmission line 130Q and the radio wave is supplied to the transmission line 130Q.

<Type of Transmission Line in which Electromagnetic Fields are Confined>

The transmission lines 130M1 to 130M8 illustrated in FIGS. 7A to 7D are transmission lines in which electromagnetic fields are confined.

The transmission line 130M1 illustrated in FIGS. 7A and 7B includes the substrate 135, a line 136M1, a ground layer 137M1, an elastic body 138M1, such as a sponge, and a metal layer 139M1. FIG. 7A illustrates an XZ cross section cut perpendicular to the extending direction (the Y direction) of the line 136M1, and FIG. 7B illustrates a YZ cross section along the extending direction (the Y direction) of the line 136M1. In FIG. 7A, the line 136M1 extends in a direction penetrating the drawing, and in FIG. 7B, the line 136M1 extends in a left-right direction.

The transmission line 130M1 is a transmission line having a triplate structure. The ground layer 137M1 is provided on the lower surface of the substrate 135, and the line 136M1 is provided on the upper surface of the substrate 135. The ground layer 137M1 is a metal foil that covers the entirety of the lower surface of the substrate 135. The configuration of the substrate 135, the line 136M1, and the ground layer 137M1 is the same as that of the microstrip line.

The elastic body 138M1 and the metal layer 139M1 are provided on the substrate 135 and the line 136M1. The sizes of the elastic body 138M1 and the metal layer 139M1 in plan view are equal to the sizes of the substrate 135 in plan view. The metal layer 139M1 is a thin metal foil, and aluminum foil can be used, for example. In the transmission line 130M1, because the lower side is covered with the ground layer 137M1 and the upper side is covered with the metal layer 139M1, the electromagnetic fields generated by the propagation of the input signal and the reflected signal through the line 136M1 are confined in the transmission line 130M1.

As illustrated in FIG. 7B, when the upper surface of the transmission line 130M1 is pressed downward, the metal layer 139M1 is recessed, so that the electric field propagating from the left side is reflected at the recessed portion. Therefore, the distance to the depressed position can be calculated. Here, because the reflection occurs at the depressed position, for example, the presence of a water droplet on the metal layer 139M1 does not affect the calculation of the distance, which is advantageous over a capacitance type sensor.

The transmission line 130M2 illustrated in FIGS. 7C and 7D includes a line 136M2, an elastic body 138M2, such as a sponge, and a ground layer 139M2. FIG. 7C illustrates an XZ cross section cut perpendicular to the extending direction (the Y direction) of the line 136M2, and FIG. 7D illustrates a YZ cross section along the extending direction (the Y direction) of the line 136M2. In FIG. 7C, the line 136M2 extends in the direction penetrating the drawing, and in FIG. 7D, the line 136M2 extends in the left-right direction.

The periphery of the line 136M2 is covered with the elastic body 138M2, and the periphery of the elastic body 138M2 is covered with the ground layer 139M2, thereby forming a configuration like a coaxial cable. Because the periphery of the line 136M2 is covered with the ground layer 139M2 in the transmission line 130M2, the electromagnetic fields generated by the propagation of the input signal and the reflected signal through the line 136M2 are confined in the transmission line 130M2.

As illustrated in FIG. 7D, when the side surface of the transmission line 130M2 is pressed toward the center, the ground layer 139M2 is recessed, so that the electric field propagating from the left side is reflected at the recessed portion. Therefore, the distance to the depressed position can be calculated. Here, because the reflection occurs at the depressed position, for example, the presence of a water droplet on the ground layer 139M2 does not affect the calculation of the distance, which is advantageous over a capacitance type sensor.

### <Application to Musical Instrument>

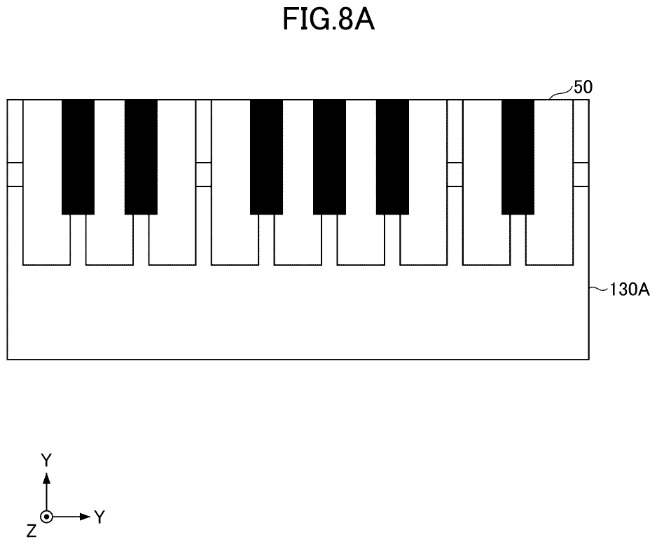

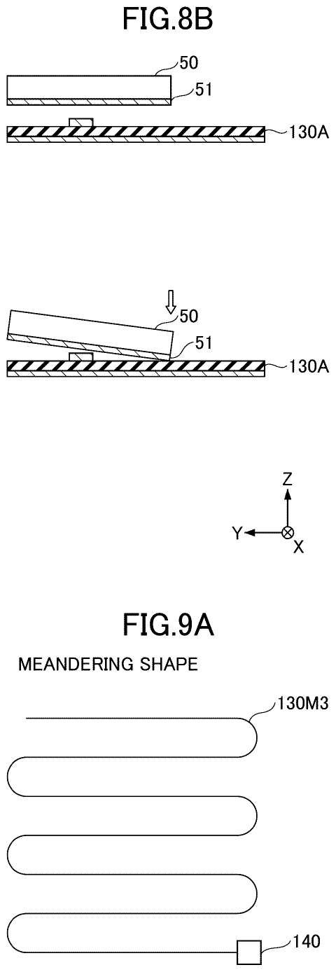

FIG. 8A is a diagram for explaining an example of application of the input device 100 to a musical instrument. FIG. 8A illustrates a configuration in which the transmission line 130A (see FIG. 6A) is arranged under keys 50 of a piano. FIG. 8B illustrates operation states of a key 50 and the transmission line 130A of the piano on the upper side and the lower side. A metal layer 51 is provided on the lower surface of the key 50. The transmission line 130 extends along a direction in which the plurality of keys 50 are arranged.

When the key 50 is depressed as illustrated in the lower side of FIG. 8B from a state in which the key 50 is not depressed as illustrated in the upper side of FIG. 8B, the metal layer 51 approaches the transmission line 130, so that which key 50 is operated can be detected by calculating the distance from the first end 131. As described, an electronic piano that detects the operated key 50 and outputs the corresponding sound can be configured.

Here, if the key 50 is provided with play in the left-right direction, the distance detected by the input device 100 can be subtly changed. In accordance with such a subtle change in the distance, the pitch of the sound to be output may be subtly raised or lowered. A sound that cannot be output by an ordinary piano can be output.

Additionally, if the transmission line 130A is used as an operation part of a musical instrument without providing the key 50, a position at which an operation is performed on the transmission line 130A can be detected in a stepless manner, so that the musical instrument having a stepless musical scale can be realized by outputting a sound of a stepless musical scale corresponding to a stepless position.

### Other Modified Example

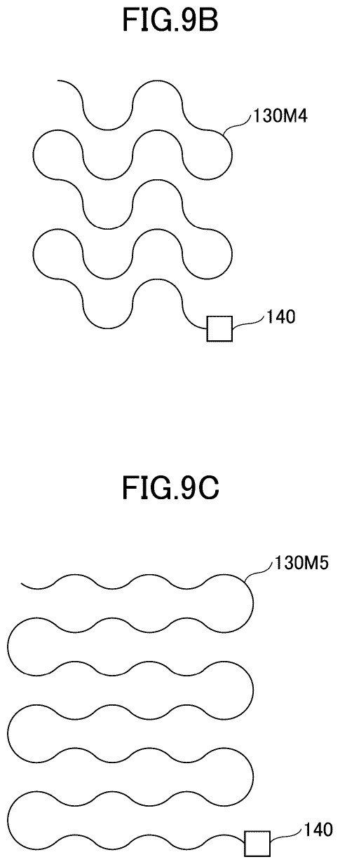

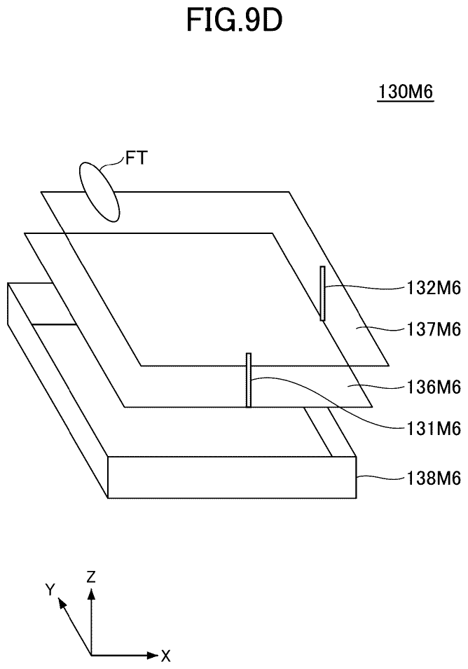

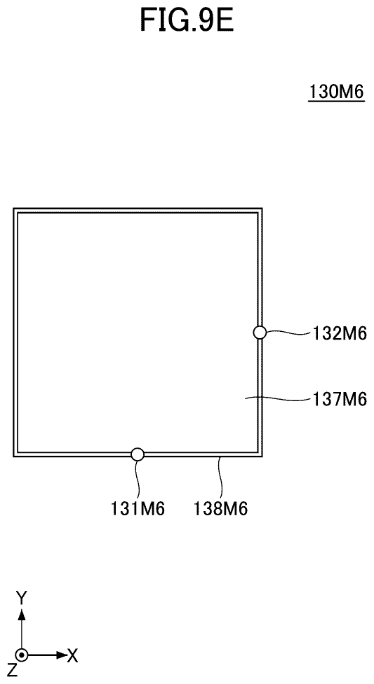

FIGS. 9A to 9C are diagrams illustrating examples of configurations of transmission lines 130M3 to 130M5 of modified examples of the embodiment. The transmission lines 130M3 to 130M5 have a planar configuration. The transmission line 130M3 illustrated in FIG. 9A is bent in a meandering shape. The transmission lines 130M4 and 130M5 illustrated in FIGS. 9B and 9C have a shape having more curved portions than the transmission line 130M3 illustrated in FIG. 9A. The transmission lines 130M3 to 130M5 may be used instead of the transmission line 130 illustrated in FIG. 1.

FIGS. 9D and 9E are diagrams illustrating an example of a configuration of a transmission line 130M6 according to a modified example of the embodiment. FIG. 9D illustrates an exploded view of the transmission line 130M3, and FIG. 9E illustrates the transmission line 130M3 in plan view.

The transmission line 130M3 includes an input/output terminal 131M6, an input/output terminal 132M6, a metal layer 136M6, a metal layer 137M6, and a radio wave absorber 138M6. For example, the metal layer 136M6 is a rectangular metal foil in plan view, and the metal layer 137M6 is a rectangular mesh-shaped metal layer in plan view. The metal layer 136M6 and the metal layer 137M6 are arranged to face each other, and are connected by the input/output terminals 131M6 and 132M6. The radio wave absorber 138M6 is provided to surround the outer edges of the metal layers 136M6 and 137M6 arranged to face each other.

The input/output terminal 131M6 connects the metal layer 136M6 to the metal layer 137M6 at the center in the X direction at the negative Y-direction side ends of the outer edges of the metal layers 136M6 and 137M6 arranged to face each other. The input/output terminal 132M6 connects the metal layer 136M6 to the metal layer 137M6 at the center in the Y direction at the positive X-direction side ends of the outer edges of the metal layers 136M6 and 137M6 arranged to face each other.

The input/output terminals 131M6 and 132M6 of the transmission line 130M6 described above correspond to the first end 131 of the transmission line 130 illustrated in FIG. 1. When two portions of the input device 100 illustrated in FIG. 1 other than the transmission line 130 are prepared and connected to the input/output terminals 131M6 and 132M6, the position of the fingertip FT in the Y direction can be detected through the input/output terminal 131M6, and the position of the fingertip FT in the X direction can be detected through the input/output terminal 132M6. That is, the XY coordinates of the fingertip FT can be located.

### <Effect>

The input device 100 includes the signal generator 110 configured to generate a waveform signal; the transmission line 130 including the first end 131 connected to the signal generator 110 and the second end 132 on the opposite side of the first end 131, and configured to transmit the waveform signal; a termination resistor 140 (the termination) connected to the second end 132 of the transmission line 130; and the position determination unit 171 configured to determine a proximate position based on an input signal that is a waveform signal input from the signal generator 110 to the transmission line 130 and a reflected signal that is generated by the input signal being reflected toward the first end 131 by an object becoming proximate to the transmission line 130 between the first end 131 and the second end 132 of the transmission line 130. Therefore, the position (the proximate position) at which the operation input is performed by the object can be determined.

Therefore, the input device 100 configured to detect the position (the proximate position) at which the operation input is performed based on the incident signal and the reflected signal can be provided.

Additionally, the position determination unit 171 may determine the proximate position based on the first signal level related to the reflected signal component of the standing wave generated based on the input signal and the reflected signal, and the second signal level related to the reflected signal component of the standing wave having a phase different from that of the first signal level by π/2. The input device 100 configured to detect, based on the first signal level and the second signal level, the position (the proximate position) at which the operation input is performed can be provided.

Additionally, the device further includes: the circulator 120 including the first terminal 121 connected to the signal generator 110, the second terminal 122 connected to the transmission line 130, and the third terminal 123, a section between the first terminal 121 and the second terminal 122 being inserted between the signal generator 110 and the transmission line 130, and a reflected signal being output from the third terminal 123; the mixer 160A including two input terminals connected to the signal generator 110 and the third terminal 123 and mixing the input signal with the reflected signal component of the standing wave to output the first signal level; the phase shifter 150 connected to the signal generator 110 and configured to shift the phase of the input signal by π/2 and output the shifted signal; and the mixer 160B including two input terminals connected to the phase shifter 150 and the third terminal 123 and configured to mix the input signal whose phase is shifted by π/2 by the phase shifter 150 with the reflected signal component of the standing wave to output the second signal level. The position determination unit 171 may determine the proximate position based on the first signal level of the first standing wave output from the mixer 160A and the second signal level of the second standing wave output from the mixer 160B. The input device 100 configured to detect, based on the first signal level of the first standing wave output from the mixer 160A and the second signal level of the second standing wave output from the mixer 160B, the position (the proximate position) at which the operation input is performed can be provided.

Additionally, if the wavelength of the radio wave at the frequency of the waveform signal is λ, the length between the first end 131 and the second end 132 of the transmission line 130 may be less than λg/2. When the length between the first end 131 and the second end 132 is less than λg/2, the input device 100 configured to detect, based on the first signal level and the second signal level of the second standing wave output from the mixer 160B, the position (the proximate position) at which the operation input is performed can be provided.

Additionally, the signal generator 110 can output a waveform signal at a plurality of frequencies, and the position determination unit 171 may obtain, for the plurality of frequencies, the voltage reflection coefficients from the first signal level of the standing wave generated based on the input signal and the reflected signal and the second signal level having a phase different from that of the first signal level by π/2, and determine the proximate position by using the plurality of voltage reflection coefficients obtained for the plurality of frequencies. The input device 100 configured to detect the position at which the operation input is performed by performing inverse Fourier transform on the plurality of voltage reflection coefficients obtained for the plurality of frequencies when the length between the first end 131 and the second end 132 of the transmission line 130 is greater than or equal to λg/2 can be provided.

Additionally, the signal generator 110 can output a waveform signal at a plurality of frequencies, and the position determination unit 171 may obtain, for the plurality of frequencies, voltage reflection coefficients from the first signal level of the standing wave generated based on the input signal and the reflected signal and the second signal level having a phase different from that of the first signal level by π/2, and may determine the proximate position by performing inverse Fourier transform on the plurality of voltage reflection coefficients obtained for the plurality of frequencies. When the length between the first end 131 and the second end 132 of the transmission line 130 is greater than or equal to λg/2, the input device 100 configured to detect the position where the operation input is performed by performing inverse Fourier transform on the plurality of voltage reflection coefficients obtained for the plurality of frequencies can be provided.

Additionally, the characteristic impedance of the transmission line 130 may be equal to the resistance value of the termination resistor 140 (the termination). Because reflection can be suppressed at the termination of the transmission line 130, an appropriate output in a state in which an operation input is not performed can be obtained.

Additionally, the waveform signal may be a sine wave signal. The input device 100 configured to detect, based on the incident signal and the reflected signal formed by the sine wave signal, the position where the operation input is performed can be provided.

Additionally, the waveform signal may be a rectangular wave signal. The input device 100 configured to detect, based on the incident signal and the reflected signal formed by a rectangular wave signal, the position where the operation input is performed can be provided.

Further, the waveform signal at the plurality of frequencies may be realized by a chirp signal. The input device 100 configured to detect the position where the operation input is performed by using a chirp signal when the length between the first end 131 and the second end 132 of the transmission line 130 is greater than or equal to λg/2 can be provided.

Although the input device of the exemplary embodiment of the present disclosure has been described above, the present disclosure is not limited to the embodiments specifically disclosed, and various modifications and changes can be made without departing from the scope of the claims.

What is claimed is:

1. An input device comprising:
a signal generator configured to generate a waveform signal;
a transmission line including a first end connected to the signal generator and a second end on an opposite side of the first end, and configured to transmit the waveform signal;
a termination connected to the second end of the transmission line; and
a position determination unit configured to determine, based on an input signal that is the waveform signal and input from the signal generator to the transmission line and a reflected signal generated by the input signal being reflected toward the first end by an object becoming proximate to the transmission line between the first end and the second end of the transmission line, a proximate position where the object is proximate to the transmission line.

2. The input device as claimed in claim 1, wherein the position determination unit determines the proximate position based on a first signal level related to a reflected signal component of a standing wave generated based on the input signal and the reflected signal, and a second signal level related to a reflected signal component of the standing wave, the second signal level having a phase different from a phase of the first signal level by π/2.

3. The input device as claimed in claim 2, further comprising:
a line connector including a first terminal connected to the signal generator, a second terminal connected to the transmission line, and a third terminal, a section between the first terminal and the second terminal being inserted between the signal generator and the transmission line, and the line connector being configured to output the reflected signal from the third terminal;
a first mixer including two input terminals connected to the signal generator and the third terminal, and configured to mix the input signal and the reflected signal component of the standing wave to output the first signal level;
a phase shifter connected to the signal generator and configured to shift a phase of the input signal by π/2 and output the shifted input signal; and
a second mixer including two input terminals connected to the phase shifter and the third terminal, and configured to mix the shifted input signal whose phase is shifted by π/2 by the phase shifter and the reflected signal component of the standing wave to output the second signal level,
wherein the position determination unit determines the proximate position based on the first signal level output from the first mixer and the second signal level output from the second mixer.

4. The input device as claimed in claim 1, wherein a length between the first end and the second end of the transmission line is less than λg/2, where λ is a wavelength of a radio wave at a frequency of the waveform signal.

5. The input device as claimed in claim 1,
wherein the signal generator is configured to output the waveform signal at a plurality of frequencies, and
wherein the position determination unit obtains, for the plurality of frequencies, a plurality of voltage reflection coefficients from a first signal level of a standing wave generated based on the input signal and the reflected signal and a second signal level having a phase different from the first signal level by π/2, and determines the proximate position by using the plurality of voltage reflection coefficients obtained for the plurality of frequencies.

6. The input device as claimed in claim 1,
wherein the signal generator is configured to output the waveform signal at a plurality of frequencies, and
wherein the position determination unit obtains, for the plurality of frequencies, a plurality of voltage reflection coefficients from a first signal level of a standing wave generated based on the input signal and the reflected signal and a second signal level having a phase different from a phase of the first signal level by π/2, and determines the proximate position by performing an inverse Fourier transform on the plurality of voltage reflection coefficients obtained for the plurality of frequencies.

7. The input device as claimed in claim 1, wherein a characteristic impedance of the transmission line is equal to a resistance value of the termination.

8. The input device as claimed in claim 1, wherein the waveform signal is a sine wave signal.

9. The input device as claimed in claim 1, wherein the waveform signal is a rectangular wave signal.

10. The input device as claimed in claim 5, wherein the waveform signal at the plurality of frequencies is realized by a chirp signal.
